(19) United States
(12) Patent Application Publication
(10) Pub. No.: US 2003/0087543 A1
(43) Pub. Date: May 8, 2003

(54) Apparatus and method of a locomotive easy connection multiple unit (MU) cable assembly

(75) Inventors: Gerald J. Hess, Erie, PA (US); Jan Alan Nagle, North East, PA (US); Shuo Chen, Erie, PA (US); Rohini Gangadharraju, Malleswaram (IN)

Correspondence Address: SENNIGER POWERS LEAVITT AND ROEDEL, ONE METROPOLITAN SQUARE, 16TH FLOOR, ST LOUIS, MO, 63102, US

(73) Assignee: General Electric Company

(21) Appl. No.: 10/274,482

(22) Filed: Oct. 18, 2002

Related U.S. Application Data
(60) Provisional application No. 60/347,955, filed on Nov. 7, 2001.

(51) Int. Cl. H01R 13/64

(52) U.S. Cl. 439/246

(57) ABSTRACT

A device for interconnecting two locomotive Multiple Unit (MU) control receptacles together. The invention provides for the introduction of a multi-piece cable assembly that includes two end-sections and a mid-section cable optionally employing a unisex connector. The invention also includes a two-section cable assembly comprising two end-sections cables each equipped with unisex connectors. The invention also includes improved methods of interconnecting two locomotive control receptacles that are less strenuous and less difficult to operate.

### BACKGROUND

This application is a non-provisional application of provisional U.S. Application No. 60/347,955, which was filed on Nov. 7, 2001.

The invention generally relates to a cable and method for linking locomotives and, in particular, to a multi-section cable which interconnects locomotive controls.

Currently, when two or more locomotives are coupled in a multiple locomotive configuration (e.g., a consist), they must be interconnected to provide for the coordinated operation and control of propulsion and braking systems so that one locomotive can control the other(s). Such coordinated control and operation is enabled by a control Multiple Unit connection located on each locomotive. Such connection is made through a cable connection referred to as a 27-Point Control Plug and Receptacle or as a Locomotive Multiple Unit (MU) Cable.

The present implementation of the industry standard MU cable connection is both difficult and strenuous for the operator who is required to make these connections. The traditional MU cable is a single section having a large heavy connector on each end. A male receptacle located on each of the locomotives receives one of the connectors at the end of the MU cable. The male receptacle is equipped with a large spring-loaded cover that also acts as a plug locking mechanism when a female plug is inserted in the male receptacle. In addition, the MU cable receptacle on the locomotive is often placed in a position that is at or above eye level.

When the operator is connecting or disconnecting the current MU cable connector, one hand must be used to hold the receptacle cover in the open unlocked position while the second hand handles and lifts the bulky connector to place it in or remove it from the receptacle on the locomotive. As a result, the operator is exposed to potential operational safety hazards such as pinching of the hands, back injuries and tripping.

### SUMMARY

The invention provides an improved interconnection between two locomotive control systems that will provide for a more convenient, less hazardous and less strenuous connection between two locomotives. The invention also provides improved methods of interconnecting two locomotives. Additionally, the invention provides an improved Multiple Unit (MU) cable assembly for use in interconnecting two locomotive control systems.

In one aspect, the invention comprises a railroad locomotive multiple-connector electrical control line cable for connecting a first control receptacle of a first locomotive to a second control receptacle of a second locomotive, with the cable being of multiple section construction. The two end-sections each have an end adapted to connect to the control receptacle of a locomotive. A mid-section has both ends adapted to connect to either the first or second end-sections, whereby an electrical connection is effected between the first and second locomotives by making up connections via the mid-section at locations spaced from the control receptacles of the locomotives.

In another aspect, the invention comprises a method of connecting a railroad locomotive multiple-connector electrical control line between a first control receptacle of a first locomotive to a second control receptacle of a second locomotive. An electrical control line cable of multiple section construction is provided. The electrical control line cable comprises a first end-section having a control plug at a first end thereof adapted to be connected to the control receptacle of the first locomotive and a second end remote from the first end. The electrical control line cable further comprises a second end-section having a control plug at a first end thereof adapted to be connected to the control receptacle of the second locomotive and a second end remote from the first end. A mid-section has ends adapted to be connected to the second ends of the end-sections. A first end of a first end-section is connected to the first control receptacle of the first locomotive. A first end of a second end-section is connected to the second control receptacle of the second locomotive. The second end of a first end-section is connected to a first end of a mid-section. The second end of the second end-section is connected to a second end of the mid-section to complete the electrical connection at a location spaced from the control receptacles.

In yet another aspect, the invention is a cable for connecting a plurality of N first wire terminations of a first control receptacle of a first locomotive to a plurality of N corresponding second wire terminations of a second control receptacle of a second locomotive. The number of wire terminations N can be any number greater than 2. In current practice, N is 27. The cable assembly is a three-section cable. A first end-section that has N first conductors terminates in first and second ends. The first end is adapted to connect to the first control receptacle such that each of the plurality of N first wire terminations of the first control receptacle is connected to a corresponding one of the N first conductors. A second end-section has N second conductors that terminate in first and second ends. The first end of the second end-section is adapted to connect to the second control receptacle such that each of the plurality of N second wire terminations of the second control receptacle is connected to a corresponding one of the N second conductors. A mid-section that has N mid-conductors terminates in first and second ends. The first end of the mid-section is adapted to connect to the second end of the first end-section such that each of the plurality of N first conductors is connected to a corresponding one of the N mid-conductors. The second end of the mid-section is adapted to connect to the second end of the second end-section such that each of the plurality of N second conductors is connected to a corresponding one of the N mid-conductors. Each of the first wire terminations of the first control receptacle of the first locomotive is electrically connected via one of the first conductors, via one of the mid-conductors and via one of the second conductors to its corresponding second wire termination of the second control receptacle of the second locomotive.

In another aspect, the invention provides for a locomotive consist which includes the interconnection of two or more locomotives by connecting a three-section cable assembly from the receptacle of a first locomotive to the receptacle of a second locomotive.

In yet another aspect of the invention, a non-biased unisex connector is provided on the second ends of the first and second end-sections and also on both ends of the mid-section. Such connector provides for the mating of any connector with any other connector of the same type and such connector does not have a male or female bias.

In yet another aspect of the invention, the cable assembly is a two-section cable assembly one section for each locomotive. The two-section cable assembly is comprised of two end-sections each of which have their second ends terminated in a non-biased unisex connector. Each cable section comprises a first end adapted to be connected to the control receptacle of the respective locomotive and having a second end terminating in a unisex connector. An electrical connection is effected between the first and second locomotives via the cable sections when connected to the control receptacles by making up a connection via the unisex connectors of the cable sections at a location spaced from the control receptacles of the locomotives.

In another aspect of the invention, a method connects a first control receptacle of a first locomotive to a second control receptacle of a second locomotive. A first end of a first end-section is connected to the first control receptacle of the first locomotive. A first end of a second end-section is connected to the second control receptacle of the second locomotive. A first unisex connector of a second end of the first end-section is connected to a second unisex connector of a second end of the second end-section.

Other aspects, forms and features of the invention will be in part apparent and in part pointed out hereinafter.

### BRIEF DESCRIPTION OF THE DRAWINGS

FIG. 1 is a schematic illustration of the three-section cable assembly for connecting two locomotives together between control receptacles.

FIG. 2 is a side view illustration of a connector in the connected position that provides for the interconnection of the various sections of the three-section cable assembly of FIG. 1.

FIG. 3 is an end perspective illustration of a single end of the cable connector as provided in FIG. 2.

FIG. 4 is a schematic side view illustration of the pin contacts at the initial stage of interconnection before the connector is locked.

FIG. 5 is a schematic side view illustration of the pin contacts after the connector has been locked.

FIG. 6 is a second schematic side view illustration of the pin contacts after the connector is in the locked connected position.

FIG. 7 is a third schematic side view illustration of the pin contacts after the connector is in a locked connected position.

FIG. 8 is a schematic illustration of the two-section cable assembly for connecting two locomotives together between control receptacles using a unisex connector.

Corresponding reference characters indicate corresponding parts throughout the drawings.

### DETAILED DESCRIPTION

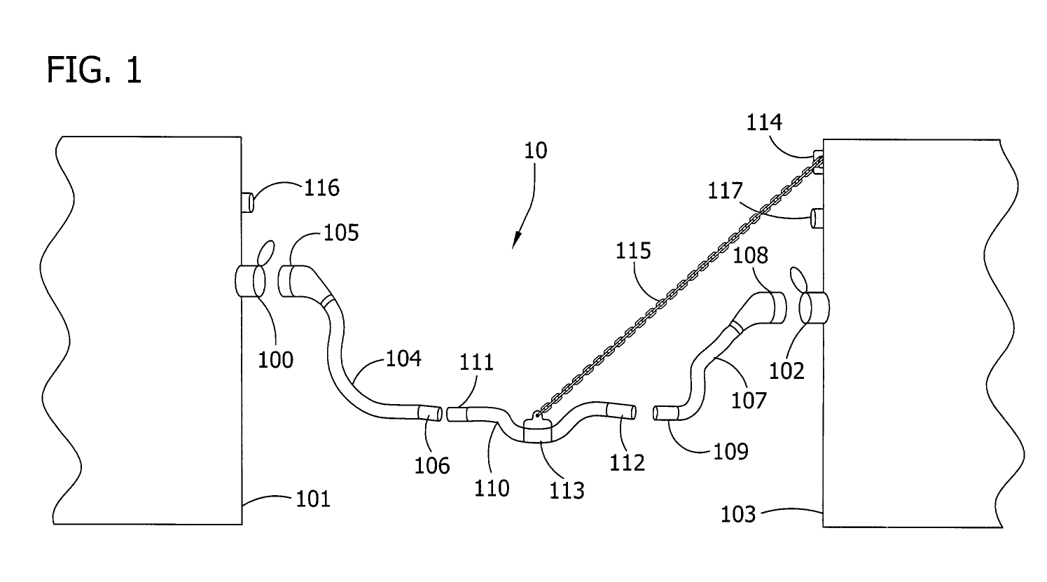

Referring to FIG. 1, a cable assembly 10 connects a first control receptacle 100 of a first locomotive 101 to a second control receptacle 102 of a second locomotive 103. Receptacle 100 has a plurality of wire terminations (such as male pins and/or female receptors), each of which needs to be electrically connected to its corresponding wire terminations of receptacle 102. Presently, each receptacle has 27 terminations so that the MU cable used to interconnect the receptacles has 27 isolated conductors of various gauge wires. In general, it is contemplated that the cable assembly 10 may be any number N of conductors.

In one embodiment of the invention, the cable assembly 10 comprises three-sections including a first end-section 104 of N conductors, a mid-section 110 of N conductors and a second end-section 107 of N conductors. The assembly 10 electrically connects each of the terminations of first control receptacle 100 via one of the conductors in the first end-section 104, via one of the mid-section conductors and via one of the conductors in the second end-section 107 to its corresponding termination of the second control receptacle 102.

The first end-section 104 has a first end 105 for engaging the first control receptacle 100 and connects the first end-section conductors to the receptacle's terminations. The second end 106 of the first end-section 104 is terminated in a connector 106 which can be any connector that will provide for the necessary connection of the first end-section conductors to the mid-section 110.

The second end-section 107 has a first end 108 that connects to the second control receptacle 102 and connects to its terminations. A second end 109 terminates in a connector that can be any connector that will provide for the necessary connection of its conductors to mid-section 110.

A mid-section 110 provides for the electrical interconnection of the first end-section 104 and the second end-section 107. The mid-section 110 has ends 111 and 112 terminating in a connector adapted to connect with the connectors of the second ends 106 and 109 of both the end-sections 104 and 107. The mid-section 110 provides an adaptor function between the two end-sections 104 and 107 by enabling the electrical connection.

While it is anticipated that the mid-section 110 will have a defined length of cable, in an alternative embodiment the mid-section 110 could be an assembly with substantially no length and comprises a back-to-back connector arrangement to enable the connection of the second end 106 of the first end-section 104 to the second end 109 of the second end-section 107.

In an optional embodiment, a hanger 113 connects the mid-section 110 to one of the locomotives 101 or 103 through a length of chain or other such standard device 115, for supporting or engaging the mid-section 110 so that the mid-section 110 is physically attached to one of the two locomotives 101 or 103 on an existing attachment 114. The hanger 113 supports at least part of the weight of the mid-section 110, as well as in the connected state, at least part of the weight of both the first and second end-sections 104 and 107.

In one alternative embodiment of the invention, cable assembly 10 is used in combination with dummy receptacles. A first dummy receptacle 116 on the first locomotive 101 receives the second end 106 of the first end-section 104. A second dummy receptacle 117 on the second locomotive 103 receives the second end 109 of the second end-section 107. The dummy receptacles 116 and 117 physically engage the second ends 106 and 109, respectively but do not necessarily provide for the electrical termination of the conductors contained therein.

In one embodiment of the invention, the connector that provides the interconnection of the end-sections 104 and 107 with the mid-section 110 is a standardized male-female connector arrangement. The first end 111 and second end 112 of the mid-section 110 are each a male connector and the second ends 106 and 109 of the first end-section 104 and the second end-section 107 are female connectors. In the connected state, the male connectors of the mid-section 110 electrically connect to the female connectors of the end-sections 104 and 107 thereby completing an end-to-end electrical connection for each of the N conductors.

An alternative embodiment of this cable assembly 10 provides for the female-male connector arrangement. In this alternative, both ends 111 and 112 of the mid-section 110 are female connectors and the second ends 106 and 109 of the first end-section 106 and the second end-sections 109 are male connectors. In the connected state, the female connectors of the mid-section 110 electrically connect to the male connectors of the first and second end-sections, 104 and 107 respectively, thereby completing an end-to-end electrical connection for each of the N conductors.

An alternative embodiment of the invention is to provide the connectors for connecting the mid-section 110 with each of the end-sections 104 and 107 through a non-biased connector. Such non-biased connector is referred to as a unisex connector. The unisex connector provides for the electrical connection of the N conductors between any two such connectors without the restriction of a proper mating of a male-female or female-male connection. Both the first 111 and second 112 ends of the mid-section 110 and each of the second ends 106 and 109 of the first end-section 104 and the second end-section 107 are unisex connectors 300 for engaging each other. In the connected state, the unisex connectors 300 of the mid-section 110 electrically connect to the unisex connectors 300 of the end-sections 104 and 107 thereby completing an end-to-end electrical connection for each of the N conductors.

In the operation of the invention, a first control receptacle 100 of a first locomotive 101 is connected to a second control receptacle 102 of a second locomotive 103 through the cable assembly 10. One step in the operation is the connection of the first end 105 of a first end-section 104 to the first control receptacle 100 of the first locomotive 101. The receptacles are standard receptacles found on many locomotives. Another step connects the first end 108 of a second end-section 107 to the second control receptacle 102 of the second locomotive 103. Another step connects the second end 106 of a first end-section 104 to the first end 111 of a mid-section 110. Yet another step connects the second end 109 of the second end-section 107 to the second end 112 of the mid-section 110. Once each of these steps is complete, the complete assembly 10 provides for the electrical connection for each individual N conductor.

Another operation of the invention provides for disconnecting a connected cable assembly 10. One step in this process is the disconnecting of the second end 106 of the first end-section 104 from the first end 111 of the mid-section 110. Another step includes disconnecting the second end 109 of the second end-section 107 from the second end 112 of the mid-section 110.

A further method of the invention provides for the storage of the end-sections 106 and 109 when the end-sections 106 and 109 are not connected with the mid-section 110. Once the end-sections 104 and 107 are disconnected from the mid-section 110, the second ends 106 and 109 of the end-sections 104 and 107 are free and need to be stored so that they are not left hanging. One solution is to store the free or non-connected second-ends 106 and 109 of the end-sections 104 and 107 in dummy receptacles 116 and 117, respectively. As one step, the second end 106 of the first end-section 104 is connected to a first dummy receptacle 116 mounted on the first locomotive 101. Another step connects the second end 109 of the second end-section 107 to the second dummy receptacle 117 mounted on the second locomotive 103. Once this process is complete, the free ends of the end-sections 104 and 107 are physically mounted in the dummy receptacles.

A further method is provided in order to reconnect the cable assembly 10 when the second ends 106 and 109 of the end-sections 104 and 107 are terminated in the dummy receptacles 116 and 117 that are mounted on the locomotives 101 and 103. The second end 106 of the first end-section 104 is disconnected from the first dummy receptacle 116. The second end 109 of the second end-section 107 is disconnected from the second dummy receptacle 117. Once the second ends 106 and 109 of the first 104 and second 107 end-sections are in a non-connected state or free, they can be connected to one of the ends of the mid-section 110. The second end 106 of the first section 104 is reconnected to the first end 111 of the mid-section 110. The second end 109 of the second end-section 107 is reconnected to the second end 112 of the mid-section 110.

An additional embodiment of the invention includes a consist of a first locomotive 101, a second locomotive 103 and the three-section cable assembly 10.

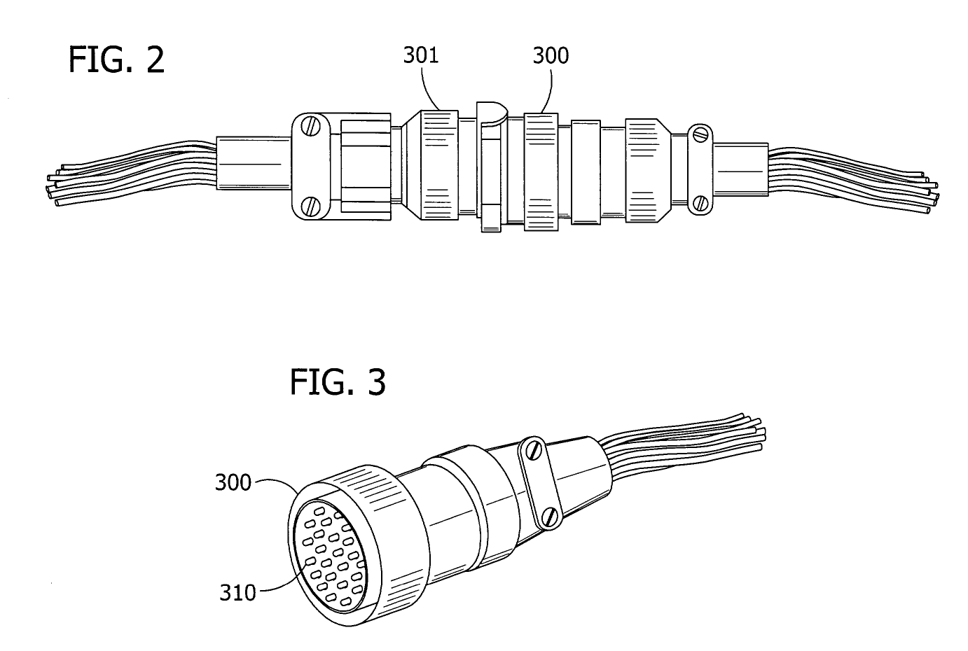

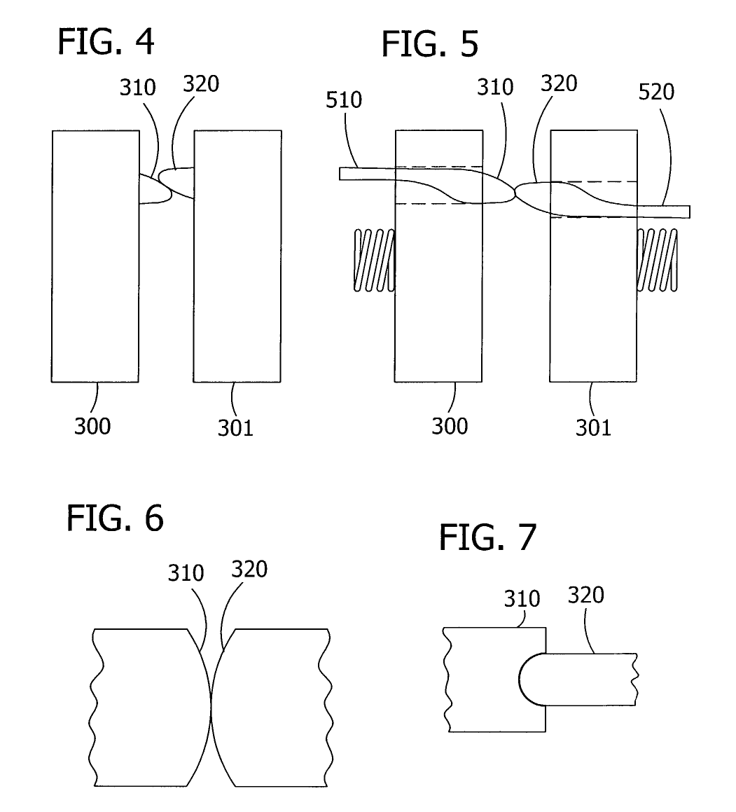

An additional embodiment of the invention is a non-biased unisex connector 300 and 301 as shown in a mated state in FIG. 2 and in the unmated state in FIG. 3 with N pins 310. In one embodiment of the invention, a mechanical interconnection between the mid-section 110 and each of the end-sections 104 and 107 may be made using mated unisex connectors as shown in FIG. 2. For example, FIG. 4 shows one embodiment where there are two unisex connectors, 300 and 301. In one embodiment, a first end-section 104 may be terminated in a first non-biased unisex connector 300 with N pins 310 and mid-section 110 may be terminated in a second non-biased unisex connector 301 with N pins 320. The individual electrical conductor pins 310 and 320 may be movably mounted in connectors 300 and 301 for axial movement while maintaining relative alignment to each other. For a mated connector arrangement there would be N such relative pin arrangements. In one embodiment, pins 310 and 320 are biased to their outward positions as shown in FIG. 4. The mechanical interconnection of pins 310 and 320 may be made in a quarter turn of the one or both of connectors 300 or 301 relative to each.

Referring now to FIG. 5, the first connector 300 is equipped with N pins 310 each of which are electrically connected to one of N wires 510. In a similar manner, the second connector 301 is equipped with N pins 320 each of which is electrically connected to one of N wires 520. As shown in FIG. 5, connector pins 310 and 320 are brought into registry when the mated connectors 300 and 301 are locked through a quarter-turn relative to each other. The mechanical connection is made to form a series of N electrical connections, one for each set of N pins 310 and N pins 320.

Other pin arrangements are also consistent with the invention. For example, FIG. 6 illustrates a schematic of the pin connections after connector 300 is in the locked position relative to connector 301 wherein pin 310 of connector 300 is in alignment with pin 320 of connector 301. In an alternative embodiment as shown in FIG. 7, pin 310 of connector 300 mechanically couples with pin 320 of connector 301.

Another embodiment of the invention is for the placement of dummy receptacles 116 and 117 on each of the locomotive 101 and 103. Such dummy receptacles may be compatible with the unisex connector 300, thereby enabling the first end-section 104 equipped with a unisex connector at the second end 106 to be placed in a first dummy receptacle 116 when the first section 104 is not in use. In a similar manner, the second end-section 107 may be equipped with a unisex connector at the second end 109 which may be placed when not in use in the second dummy receptacle 117.

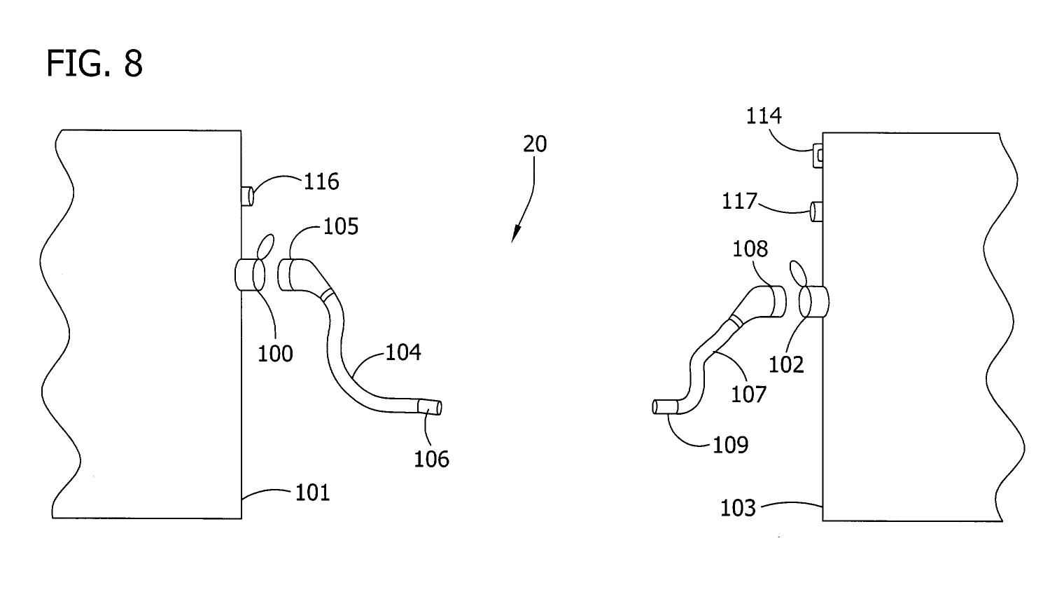

Now referring to FIG. 8, another embodiment of the invention is for the cable assembly 20 to be a two-section assembly 20 comprising two-end-sections 104 and 107. The two-end-sections 104 and 107 are each terminated in unisex connectors 300 and 301 that engage each other. In the operation of this embodiment of the invention, a first control receptacle 100 of a first locomotive 101 is connected to a second control receptacle 102 of a second locomotive 103 through the cable assembly 20. One step in the operation is the connection of the first end 105 of a first end-section 104 to the first control receptacle 100 of the first locomotive 101. Another step is connecting the first end 108 of a second end-section 107 to the second control receptacle 102 of the second locomotive 103. Another step connects the unisex connector 300 of the second end 106 of a first end-section 104 to the unisex connector 301 of the second end 109 of the second end-section 107. Once the unisex connectors 300 and 301 are mated together, the two-section cable assembly 20 provides for the electrical connection between the wire terminations of the receptacles. As noted above, when the two second-ends 106 and 109 are not in use, a dummy receptacle is available to store the cables. As in FIG. 8, the second end 106 of the first end-section 104 may be stored in dummy receptacle 116 when not engaged with the second end-section 109 of a second locomotive 103. Similarly, the second end 109 of the second end-section 107 may be stored in dummy receptacle 114 when not engaged with the first end-section 104. This embodiment provides improved operation of interconnecting locomotives in a consist due to its improved design and ease of operation.

An additional embodiment of the invention includes a consist of a first locomotive 101, a second locomotive 103 and the two-section cable assembly 20.

As illustrated in FIG. 1, each of the sections of the assembly 10 is shown to have a length. Alternatively, it is contemplated that any one or more of the sections have essentially no length and would be an adapter. For example, as noted above, mid-section 110 may be an adapter for engaging the free ends 106 and 109 of the sections 104 and 107. As another example, either or both sections 104, 107 may be an adapter for converting the receptacles 100 and 102 into a unisex or other connector for engaging the free ends of the mid-section 110.

In view of the above, the invention provides advantages and improvements over the prior art.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements. As various changes could be made in the above products without departing from the scope of the invention, it is intended that all matter contained in the above description and shown in the accompanying drawings shall be interpreted as illustrative and not in a limiting sense.

What is claimed is:

1. A railroad locomotive multiple-connector electrical control line cable for connecting a first control receptacle of a first locomotive to a second control receptacle of a second locomotive, said cable being of multiple section construction and comprising:
a first end-section having a first end adapted to connect to the first control receptacle of the first locomotive and having a second end;
a second end-section having a first end adapted to connect to the second control receptacle of the second locomotive and having a second end; and
a mid-section having a first end adapted to connect to the second end of the first end-section and having a second end adapted to connect to the second end of the second end-section, whereby an electrical connection is effected between the first and second locomotives by making up connections via the mid-section at locations spaced from the control receptacles of the locomotives.

2. A cable as recited in claim 1 further comprising a hanger adapted to connect to one of the locomotives and to the mid-section wherein the mid-section is supportively attached to the locomotive.

3. A cable as recited in claim 1 further comprising a first dummy receptacle on the first locomotive for receiving the second end of the first end-section and a second dummy receptacle on the second locomotive for receiving the second end of the second end-section.

4. A cable as recited in claim 1 wherein the first and second end-sections are of same design, including at their ends.

5. A cable as recited in claim 4 wherein the first and second ends of the mid-section are each a male connector and wherein the second end of the first end-section is a female connector for connecting to one of the male connectors and wherein the second end of the second end-section is a female connector for connecting to the other of the male connectors.

6. A cable as recited in claim 4 wherein the first and second ends of the mid-section are each female connectors and wherein the second end of the first end-section is a male connector for connecting to one of the male connectors and wherein the second end of the second end-section is a male connector for connecting to the other of the male connectors.

7. A cable as recited in claim 1 wherein the first and second ends of the mid-section and each of the second ends of the end-sections are unisex connectors for engaging each other.

8. A method of connecting a railroad locomotive multiple-connector electrical control line between a first control receptacle of a first locomotive to a second control receptacle of a second locomotive, said method comprising:
providing an electrical control line cable of multiple section construction comprising a first end-section having a control plug at a first end thereof adapted to be connected to the control receptacle of the first locomotive and a second end remote from the first end, a second end-section having a control plug at a first end thereof adapted to be connected to the control receptacle of the second locomotive and a second end remote from the first end, and a mid-section with ends adapted to be connected to the second ends of the end-sections;
connecting a first end of a first end-section to the first control receptacle of the first locomotive;
connecting a first end of a second end-section to the second control receptacle of the second locomotive;
connecting a second end of a first end-section to a first end of a mid-section; and
connecting a second end of a second end-section to a second end of the mid-section to complete the electrical connection at a location spaced from the control receptacles.

9. A method as recited in claim 8, further comprising the steps of:
disconnecting the second end of the first end-section from the first end of the mid-section; and
disconnecting the second end of the second end-section from the second end of the mid-section.

10. A method as recited in claim 9, further comprising:
connecting the second end of the first end-section to a first dummy receptacle; and
connecting the second end of the second end-section to a second dummy receptacle.

11. A method as recited in claim 10, further comprising:
disconnecting the second end of the first end-section from the first dummy receptacle;
disconnecting the second end of the second end-section from the second dummy receptacle;
re-connecting the second end of the first section to the first end of the mid-section; and
reconnecting the second end of the second end-section to the second end of the mid-section.

12. A consist comprising:
a first locomotive having a first control receptacle;
a second locomotive having a second control receptacle;
a first end-section having a first end adapted to connect to the first control receptacle and having a second end;
a second end-section having a first end adapted to connect to the second control receptacle and a having a second end; and
a mid-section having a first end adapted to connect to the second end of the first end-section and having a second end adapted to connect to the second end of the second end-section.

13. A cable as recited in claim 12 further comprising a hanger adapted to connect to one of the locomotives for engaging the mid-section wherein the mid-section is supportively attached to the locomotive.

14. A cable as recited in claim 12 further comprising a first dummy receptacle on the first locomotive for receiving the second end of the first end-section and a second dummy receptacle on the second locomotive for receiving the second end of the second end-section.

15. A cable as recited in claim 12 wherein the first and second ends of the mid-section are each a male connector and wherein the second end of the first end-section is a female connector for connecting to one of the male connectors and wherein the second end of the second end-section is a female connector for connecting to the other of the male connectors.

16. A cable as recited in claim 12 wherein the first and second ends of the mid-section are each female connectors and wherein the second end of the first end-section is a male connector for connecting to one of the male connectors and wherein the second end of the second end-section is a male connector for connecting to the other of the male connectors.

17. A cable as recited in claim 12 wherein the first and second ends of the mid-section and each of the second ends of the end-sections are unisex connectors for engaging each other.

18. A cable for connecting a plurality of N first wire terminations of a first control receptacle of a first locomotive to a plurality of N corresponding second wire terminations of a second control receptacle of a second locomotive, where N is greater than 2, said cable comprising:
a first end-section having N first conductors terminating in first and second ends, the first end adapted to connect to the first control receptacle such that each of the plurality of N first wire terminations of the first control receptacle is connected to a corresponding one of the N first conductors;
a second end-section having N second conductors terminating in first and second ends, the first end of the second end-section adapted to connect to the second control receptacle such that each of the plurality of N second wire terminations of the second control receptacle is connected to a corresponding one of the N second conductors; and
a mid-section having N mid-conductors terminating in first and second ends, the first end of the mid-section adapted to connect to the second end of the first end-section such that each of the plurality of N first conductors is connected to a corresponding one of the N mid-conductors, the second end of the mid-section adapted to connect to the second end of the second end-section such that each of the plurality of N second conductors is connected to a corresponding one of the N mid-conductors wherein each of the first wire terminations of the first control receptacle of the first locomotive is electrically connected via one of the first conductors, via one of the mid-conductors and via one of the second conductors to its corresponding second wire termination of the second control receptacle of the second locomotive.

19. A railroad locomotive multiple-connector electrical control line cable for connecting a control receptacle of a first locomotive to a control receptacle of a second locomotive, said cable being of two section construction, one section for each locomotive, with each cable section comprising:
a first end adapted to be connected to the control receptacle of the respective locomotive and having a second end terminating in a unisex connector, whereby an electrical connection is effected between the first and second locomotives via the cable sections when connected to the control receptacles by making up a connection via the unisex connectors of the cable sections at a location spaced from the control receptacles of the locomotives.

20. A method of connecting a first control receptacle of a first locomotive to a second control receptacle of a second locomotive, said method comprising:
connecting a first end of a first end-section to the first control receptacle of the first locomotive;
connecting a first end of a second end-section to the second control receptacle of the second locomotive; and
connecting a first unisex connector of a second end of the first end-section to a second unisex connector of a second end of the second end-section.
